(19) United States
(12) Patent Application Publication
(10) Pub. No.: US 2025/0013532 A1
(43) Pub. Date: Jan. 9, 2025

(54) METHOD AND APPARATUS FOR ON-DIE AND IN-CONTROLLER COLLABORATIVE MEMORY ERROR CORRECTION

(71) Applicant: The Regents of the University of California, Oakland, CA (US)

(72) Inventors: Puneet Gupta, Los Angeles, CA (US); Irina Alam, Los Angeles, CA (US)

(21) Appl. No.: 18/580,354

(22) PCT Filed: Jul. 19, 2022
(86) PCT No.: PCT/US2022/037625

§ 371 Date: Jan. 18, 2024

Related U.S. Application Data
(60) Provisional application No. 63/223,482, filed on Jul. 19, 2021.

(51) Int. Cl. G06F 11/10

(52) U.S. Cl. CPC G06F 11/1068; G06F 11/1048

(57) ABSTRACT

The present embodiments relate to a Collaborative Memory ECC Technique (COMET), a method to efficiently co-design the two ECC codes of an on-die ECC decoder and an in-controller ECC decoder to guarantee no silent data corruption when a double-bit error happens within the DRAM. Further proposed is a collaboration mechanism between the on-die and in-controller ECC decoders that corrects most of these double-bit errors without adding any additional redundancy bits to either of the two codes. Overall, COMET can eliminate all double-bit error induced silent data corruptions and correct virtually all (99.9997%) double bit errors with negligible area, power and performance impact.

### CROSS-REFERENCE TO RELATED APPLICATIONS

The present application claims priority to U.S. Provisional Patent Application No. 63/223,482 filed Jul. 19, 2021, the contents of which are incorporated herein by reference in their entirety.

### TECHNICAL FIELD

The present embodiments relate generally to error correction in a memory controller, and more particularly to an on-die and in-controller collaborative memory ECC technique for stronger and safer correction of DRAM errors.

### BACKGROUND

DRAM manufacturers have started adopting on-die error correction coding (ECC) to deal with increasing error rates. The typical single error correction (SEC) ECC on memory die is coupled with a single-error correcting, double-error detecting (SECDED) ECC in the memory controller. Unfortunately, the on-die SEC can miscorrect double bit errors (which would have been safely detected but uncorrected errors in conventional in-controller SECDED) resulting in triple bit errors more than 45% of the time which are then undetectable or miscorrected in the memory controller >55% of the time resulting in silent data corruption (SDC).

In addition to the problem of SDCs, it has been observed that for every 128-bits of data, with on-die and in-controller ECC schemes combined there are now 8 more bits of parity bits as compared to only in-controller ECC. While these 8-bits help to take care of single-bit errors within the chip, they do not provide much additional benefit because in-controller ECC was already correcting single-bit errors. In the case when a single-bit fault outside the memory array coincides with a single-bit error in the chip, the in-controller ECC now sees only the bit-flip introduced by the external fault and is, therefore, able to correct it. Other than that, the on-die SEC is not improving protection on top of what the in-controller code was already doing.

It is against this technological backdrop that the present Applicant sought a technological solution to these and other problems rooted in this technology.

### SUMMARY

According to certain aspects, the present disclosure relates to a Collaborative Memory ECC Technique (COMET) that allows one to efficiently design on-die and in-controller error correcting code implementations that will not only correct single-bit errors but will also correct majority of double-bit errors and completely avoid silent data corruption with no additional parity bits.

One or more embodiments relate to a methodology to efficiently design the on-die single error correcting code. The design technique exploits the overall memory system architecture and steers the miscorrected bit when a double-bit error occurs in such a way that the in-controller SECDED code, irrespective of its actual implementation, never encounters all three bits of errors in the same decoding cycle. As a result, there can never be miscorrections within the controller and thus, ensures complete protection against silent data corruption in the case of double bit errors.

It is understood that on-die code construction is done by memory vendors and system architects have no control over the actual implementation. Hence, one or more embodiments relate to a methodology to efficiently construct the in-controller SECDED code for a given on-die SEC implementation and memory system architecture. Thus, even if the SEC code is not designed to take care of SDC in the case of double-bit errors, the SECDED code can be designed to take care of it.

Additionally or alternatively, one or more embodiments relate to a detailed collaborative double-bit error correction technique using the on-die and in-controller decoders. For this technique to work, the SEC code needs to be designed with an additional constraint and the memory controller would need to send a special command with additional information once a DUE is flagged. This collaborative technique can correct almost all (99.9997%) double-bit errors (except in one rare case) and does not introduce any miscorrection or silent data corruption.

In one or more additional or alternative embodiments, implemented and synthesized are example SEC encoder and decoder circuits in a commercial technology to compare the area, energy and latency overheads with that of the most efficient SEC implementation possible. SEC-COMET implementations require no additional parity bits, have less than 5% decoder area and latency overheads and less than 10% power overhead as compared to the most efficient SEC construction. The COMET correction mechanism has negligible performance impact (less than 1% across 18 SPEC 2017 benchmarks) even for a high scaling bit error rate of 10⁻⁴.

### BRIEF DESCRIPTION OF THE DRAWINGS

These and other aspects and features of the present embodiments will become apparent to those ordinarily skilled in the art upon review of the following description of specific embodiments in conjunction with the accompanying figures, wherein:

FIGS. 1A and 1B illustrate an example showing the difference when a double-bit error occurs between systems with DRAMs that have no on-die SEC mechanism versus one with DRAMs equipped with on-die SEC coding, respectively.

FIG. 2 is a functional block diagram providing a side-by-side visual representation of example SEC and SECDED coding schemes.

FIG. 3 is a graph illustrating a probability of SDC for every 64-bits of SCEDED dataword read from memory when a double-bit error occurs in a system with (136,128) on-die SEC and (72,64) in-controller SECDED coding schemes for different bit error rates and data access protocols.

FIG. 4 is a block diagram illustrating an example showing how steering the miscorrected bit to a different beat transfer boundary during SEC decoding prevents the SECDED decoder from encountering the problematic triple-bit error within the same 72-bit codeword according to embodiments.

FIG. 5 is a block diagram illustrating an example showing SDC occurring due to miscorrection introduced by on-die ECC according to embodiments.

FIGS. 6A to 6D are functional block diagrams illustrating example scenarios possible when one chip has double bit error and another chip has single bit error that aligns in a way leading to multiple DRAM chips modifying data during DBE correction according to embodiments.

FIG. 7 is a flowchart illustrating an example COMET double-bit error correction mechanism according to embodiments.

FIG. 8 is a graph illustrating an example impact of on-die ECC induced SDC in the event of double-bit error on the program behavior when running applications from the AxBench suite in accordance with embodiments.

### DETAILED DESCRIPTION

The present embodiments will now be described in detail with reference to the drawings, which are provided as illustrative examples of the embodiments so as to enable those skilled in the art to practice the embodiments and alternatives apparent to those skilled in the art. Notably, the figures and examples below are not meant to limit the scope of the present embodiments to a single embodiment, but other embodiments are possible by way of interchange of some or all of the described or illustrated elements. Moreover, where certain elements of the present embodiments can be partially or fully implemented using known components, only those portions of such known components that are necessary for an understanding of the present embodiments will be described, and detailed descriptions of other portions of such known components will be omitted so as not to obscure the present embodiments. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the present disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present embodiments encompass present and future known equivalents to the known components referred to herein by way of illustration.

### Introduction

Increasing capacity and aggressive technology scaling in modern DRAM chips have made it challenging for memory manufacturers to maintain acceptable yield and reliability at sub-20 nm technology nodes (See M. Jung, C. Weis, N. Wehn, M. Sadri, and L. Benini, “Optimized active and power-down mode refresh control in 3d-drams,” in 2014 22nd International Conference on Very Large Scale Integration (VLSI-SoC), 2014, pp. 1-6; Sanghyuk Kwon, Young Hoon Son, and Jung Ho Ahn, “Understanding ddr4 in pursuit of in-dram ecc,” in 2014 International SoC Design Conference (ISOCC), 2014, pp. 276-277; J. Liu, B. Jaiyen, Y. Kim, C. Wilkerson, and O. Mutlu, “An experimental study of data retention behavior in modern dram devices: Implications for retention time profiling mechanisms,” in Proceedings of the 40^{th} Annual International Symposium on Computer Architecture, ser. ISCA '13. New York, NY, USA: Association for Computing Machinery, 2013, p. 60-71. [Online]. Available: https://doi.org/10.1145/2485922.2485928; and “ECC Brings Reliability and Power Efficiency to Mobile Devices,” Micron technology, Inc., Tech. Rep., 2017). With increasing rates of scaling induced errors, the traditional method of row/column sparing used by DRAM vendors to tolerate manufacturing faults has started incurring large overheads. In order to improve yields and provide protection against single-bit failures in the DRAM array at advanced technology nodes, memory manufacturers have started incorporating on-die error correction coding (on-die ECC) that helps to correct single-bit errors.

When writing data, an on-die ECC encoder generates the ECC parity bits internally within the DRAM chip and stores them in redundant storage within the chip. While reading data, the parity bits are read and the decoder tries to correct any single bit error in the data. The redundant parity bits are not sent out of the chip, only the actual data, post correction, is sent out of the DRAM chip making on-die ECC transparent to the outside world. Though DRAM manufacturers do not usually reveal their on-die ECC design and implementation, prior works (e.g. P. J. Nair, V. Sridharan, and M. K. Qureshi, “Xed: Exposing on-die error detection information for strong memory reliability,” in 2016 ACM/IEEE 43rd Annual International Symposium on Computer Architecture (ISCA), 2016, pp. 341-353; M. Patel, J. S. Kim, H. Hassan, and O. Mutlu, “Understanding and modeling on-die error correction in modern dram: An experimental study using real devices,” in 2019 49th Annual IEEE/IFIP International Conference on Dependable Systems and Networks (DSN), 2019, pp. 13-25; and M. Patel, J. S. Kim, T. Shahroodi, H. Hassan, and O. Mutlu, “Bit-exact ecc recovery (beer): Determining dram on-die ecc functions by exploiting dram data retention characteristics,” 2020) and industry whitepapers indicate the most commonly used scheme is (136,128) Single Error Correcting (SEC) Hamming code (see e.g. R. W. Hamming, “Error detecting and error correcting codes,” The Bell System Technical Journal, vol. 29, no. 2, pp. 147-160, 1950) which corrects any single-bit error that occurs in 128 bits of actual data with the help of 8 bits of additional parity. On-die ECC is typically paired with rank-level single error correction, double error detection (SECDED) error correction technique in the memory controller. The main focus of in-controller ECC is to correct errors that are visible outside the memory chip, mostly due to failures in pins, sockets, buses, etc.

With the inclusion of on-die SEC, single-bit errors (SBE) get corrected within the DRAM chip. SBEs are still the most dominant failure mode in the DRAM arrays. Therefore, on-die ECC helps to reduce the occurrence of uncorrectable errors being detected in the controller that used to happen when a single-bit error in the DRAM would intersect with a link or pin failure outside the chip. But, with increasing error rate, double-bit errors (DBE) within the array itself is no longer a rarity. However, a double error correcting (DEC) code incurs twice the storage, area and latency overhead as compared to SEC. As a result, it is not practical for DRAM manufacturers to have on-die DEC mechanism. The expectation in high reliability systems is that, to get protection against double bit errors, the rank-level in-controller coding scheme will detect it and the system can restart or roll back to a checkpoint. (J. Chung, I. Lee, M. Sullivan, J. H. Ryoo, D. W. Kim, D. H. Yoon, L. Kaplan, and M. Erez, “Containment domains: A scalable, efficient, and flexible resilience scheme for exascale systems,” in SC '12: Proceedings of the International Conference on High Performance Computing, Networking, Storage and Analysis, 2012, pp. 1-11).

However, the on-die SEC code reduces the efficacy of in-controller double-bit error detection and significantly increases the chances of silent data corruption (SDC). This is because previously, the data would go through a single round of decoding inside the memory controller and the SECDED decoder could flag any DBE that would have occurred.

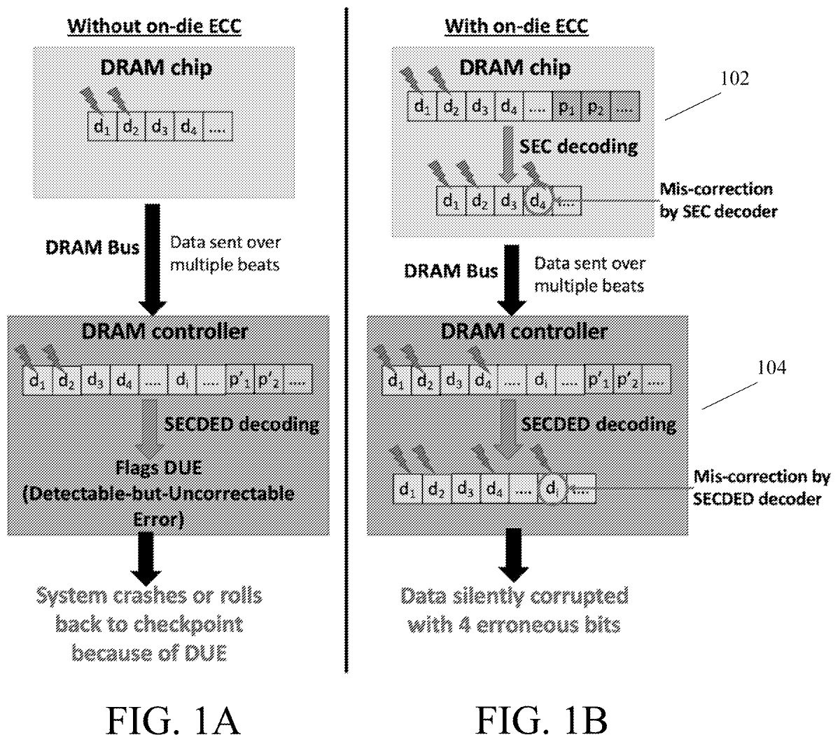

FIGS. 1A and 1B illustrate an example showing the difference when a double-bit error occurs between systems with DRAMs that have no on-die SEC mechanism (FIG. 1A) versus one with DRAMs equipped with on-die SEC coding (FIG. 1B). Both systems have an in-controller SECDED. In this example, it is assumed that the data and parity bits that get decoded in the DRAM controller in one cycle are sent from the same DRAM chip across multiple beats. The in-controller SECDED decoder in the system with no on-die ECC in FIG. 1A correctly flags a DUE because the double-bit error remains as is. In the system with on-die SEC in FIG. 1B the double-bit error changes to triple-bit error post correction with the DRAM die and further gets silently corrupted post SECDED decoding.

More particularly, with on-die SEC as shown in FIG. 1B, the data goes through two rounds of decoding. The SEC decoder in the first round 102 only ensures protection against SBEs. For DBEs, the decoder, has a >45% (on an average, the miscorrection probability slightly varies based on the actual SEC implementation) of miscorrection resulting in a triple bit error. In the second round 104 of decoding, the in-controller SECDED decoder provides protection up-to two bits of errors. The moment the error count increases to three, the decoder has ˜55% chance of considering this as a single bit error and flips a bit in order to correct it. Thus, post SECDED correction, the memory controller thinks it has the right data since the decoder could correct it, and send the corrupted data over to the processor. For a rawbit error rate of 10⁻⁴ that is often seen in recent works and experimental studies (e.g. P. J. Nair, V. Sridharan, and M. K. Qureshi, “Xed: Exposing on-die error detection information for strong memory reliability,” in 2016 ACM/IEEE 43rd Annual International Symposium on Computer Architecture (ISCA), 2016, pp. 341-353; M. Patel, J. S. Kim, T. Shahroodi, H. Hassan, and O. Mutlu, “Bit-exact ecc recovery (beer): Determining dram on-die ecc functions by exploiting dram data retention characteristics,” 2020; and P. J. Nair, D.-H. Kim, and M. K. Qureshi, “Archshield: Architectural framework for assisting dram scaling by tolerating high error rates,” in Proceedings of the 40^{th} Annual International Symposium on Computer Architecture, ser. ISCA '13. New York, NY, USA: Association for Computing Machinery, 2013, p. 72-83. [Online]. Available: https://doi.org/10.1145/2485922.2485929), one can expect silent data corruption once every ˜300,000 SECDED decoding cycles (or 64-bit memory access) in a system with a single DRAM chip that has on-die (136,128) SEC and in-controller (72, 64) SECDED protection mechanisms. Thus, the present Applicant recognizes that on-die ECC actually worsens memory reliability in the case of double-bit errors. Instead of the in-controller decoder always flagging actual DUEs in the case of the example of FIG. 1A, there is now a significantly high probability of silent data corruption (SDC) in the case of the example of FIG. 1B.

In addition to the problem of SDCs, another issue Applicant has recognized is that for every 128-bits of data, with on-die and in-controller ECC schemes combined there now are 8 more bits of parity bits as compared to only in-controller ECC. While these 8-bits help to take care of single-bit errors within the chip, they do not provide much additional benefit because the in-controller ECC was already correcting single-bit errors. In the case when a single-bit fault outside the memory array coincide with a single-bit error in the chip, the in-controller ECC now sees only the bit-flip introduced by the external fault and is, therefore, able to correct it. Other than that, the on-die SEC is not improving protection on top of what the in-controller code was already doing. So, with 8-bits of parity, it would be desirable if corresponding additional benefits could be achieved.

It should be noted that although only one DRAM chip is shown in FIGS. 1A and 1B, that there can be several for a given single controller, some or all having their own on-die error correction decoders. Moreover, although the present embodiments describe an example of DRAM memory, other types of memory are possible, such as static RAM, ROM, flash memory, etc.

### DRAM Operation

Dynamic Random Access Memory (DRAM) chip cell consists of a transistor and a capacitor. The cell stores a single bit of data in the capacitor where the charge level of the capacitor represents the stored value (see K. K. Chang, A. Kashyap, H. Hassan, S. Ghose, K. Hsieh, D. Lee, T. Li, G. Pekhimenko, S. Khan, and O. Mutlu, “Understanding latency variation in modern dram chips: Experimental characterization, analysis, and optimization,” in Proceedings of the 2016 ACM SIGMETRICS International Conference on Measurement and Modeling of Computer Science, ser. SIGMETRICS '16. New York, NY, USA: Association for Computing Machinery, 2016, p. 323-336. [Online]. Available: https://doiorg/10.1145/2896377.2901453; and K. K. Chang, D. Lee, Z. Chishti, A. R. Alameldeen, C. Wilkerson, Y. Kim, and O. Mutlu, “Improving dram performance by parallelizing refreshes with accesses,” in 2014 IEEE 20th International Symposium on High Performance Computer Architecture (HPCA), 2014, pp. 356-367). These cells are organized in two dimensional arrays called banks to reduce the control overheads. Every cell sits at the intersection of a row and column and can be accessed using a particular row and column address combination. A read/write command usually accesses a small subset of columns in a row and includes multiple steps. First the entire row is read into a row buffer using the ACTIVATE command. Then a READ/WRITE command is sent with the column address to initiate the data transfer.

Most DRAMs use multiple data pins (DQs) in parallel during data transfer (see A. N. Udipi, N. Muralimanohar, N. Chatterjee, R. Balasubramonian, A. Davis, and N. P. Jouppi, “Rethinking dram design and organization for energy-constrained multi-cores,” in Proceedings of the 37th Annual International Symposium on Computer Architecture, ser. ISCA '10. New York, NY, USA: Association for Computing Machinery, 2010, p. 175-186. [Online]. Available: https://doi.org/10.1145/1815961.1815983; and Y. Kim, V. Seshadri, D. Lee, J. Liu, and O. Mutlu, “A case for exploiting subarray-level parallelism (salp) in dram,” in 2012 39th Annual International Symposium on Computer Architecture (ISCA), 2012, pp. 368-379). A DRAM with N DQ signals is called a xN chip. Typically, more than one DRAM chip is accessed together in parallel to improve bandwidth and they together form a rank. A single DRAM access takes multiple cycles—during each cycle a beat of data (N bits from every chip in a rank) is transferred and the number of beats transferred in each access constitutes the memory burst length. The number of cycles per access and the width of a data beat accessed in each cycle depends on the memory system architecture and the data access protocol. If a rank consists of 8×8 DRAMs and the burst length is 8 beats, it translates to 64-bits of data transfer per beat and a total of 64 B transfer per READ/WRITE command.

### Linear Hamming Error Correcting Codes-Key Concepts

An error correcting code (ECC) detects and/or corrects by adding redundant parity bits to the original data. A (n;k) Hamming code protects a k-bit dataword (original data) by encoding the data through linear transformation to form a n-bit codeword. The number of parity bits is equal to n−k. Increasing the number of parity bits increases the codeword space and therefore, helps to increase the minimum Hamming distance between two distinct legal n-bit codewords. The distance of a code determines its error detection and correction capabilities.

A code of minimum distance dₘᵢₙ is guaranteed to correct t=½(dₘᵢₙ−1) erroneous symbols. The encoding is done by multiplying the dataword (˜m) with the generator matrix G: ˜mG=˜c and the resulting codeword ˜c is written to memory. When the system reads the memory address of interest, the ECC decoder hardware obtains the received codeword ˜x=˜c+˜e. Here, ˜e is an error-vector of length n that represents where memory faults, if any, have resulted in changed bits/symbols in the codeword. The decoder multiplies the received codeword ˜x with parity check matrix H to calculate the error syndrome: ˜s=H˜x^{T}.

The following conclusions can be drawn from the syndrome: If s=0: No error; If s!=0: Error detected, and syndrome is matched with columns of the parity check matrix H to determine the exact bit-location of the error. If the syndrome matching is unsuccessful, the decoder declares it as a detectable-but-uncorrectable error (DUE).

The syndrome is generated without any knowledge about the exact number of errors in the received codeword. If the number of errors exceeds the correction capability of the code and the syndrome matching is successful it would mean one of the following scenarios have occurred: If s=0: The decoder declares the codeword error-free and all bits of errors go undetected; If s!=0 and points to a bit, then this bit can be one of the erroneous bits or a non-erroneous bit. In either case the decoder will flag a CE and miscorrect that bit.

This leads to silent data corruption (SDC) where the decoder wrongly declares data with errors as correct and the controller sends the erroneous data to the processor. Among other things, the present embodiments attempt to reduce such SDC events when double-bit errors occur.

### On-Die SEC

Single-Error Correcting (SEC) codes (dₘᵢₙ=3) are simple and effective against soft faults. They can correct all possible single-bit errors. The parity-check matrix H of a linear SEC code satisfies the following properties: 1. All columns are distinct (and non-zero); and 2. The minimum number of columns to form a linearly dependent set is 3.

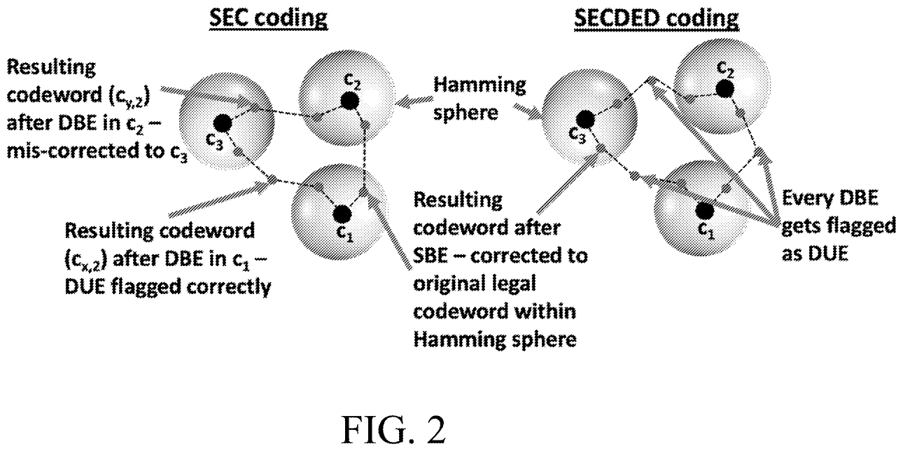

These constraints ensure that every legal codeword is at-least 3 bit flips away from each other as shown in FIG. 2. When a single-bit error occurs, the resulting codeword is one bit flip away from the correct codeword and therefore, falls within the Hamming sphere of that legal codeword. Hence the decoder can correct it. However, if two errors happen, the resulting codeword can either fall in-between two Hamming spheres (c_{x,2} in FIG. 2) or can end up in the Hamming sphere of another legal codeword (c_{y,2} in FIG. 2). In the first case the decoder generates a non-zero syndrome but is unable to match it with any column in the H matrix. In the second case, the decoder matches the non-zero syndrome with one of the H columns and flips a non-erroneous bit as part of the correction attempt to finally generate an erroneous codeword with three bits of errors.

### In-Controller SECDED

Single-Error Correcting, Double-Error Detecting (SECDED) codes (dₘᵢₙ=4) can correct all possible single-bit errors (SBE) and detect all possible double-bit errors (DBE). The parity-check matrix H of a linear SECDED code satisfies the following properties: 1. All columns are distinct (and non-zero); and 2. The minimum number of columns to form a linearly dependent set is 4.

The most common SECDED codes are the [72; 64; 4]₂ and [39;32;4]₂ Hsiao constructions (see M. Y. Hsiao, “A Class of Optimal Minimum Odd-Weight-Column SEC-DED Codes,” IBM Journal of Research and Development, vol. 14, no. 4, pp. 395-401, 1970). Hsiao codes are in systematic form and minimize the number of logic gates in the decoder, which is one reason why they are commonly used today. These are particular truncations of (127,120) and (63,57) SEC Hamming codes, respectively, that were each supplemented with an extra overall parity bit to achieve double error detecting property. As shown in FIG. 2, every legal codeword is at least three bit flips away from each other. Thus, in the event of a DBE, the resulting codeword always lands in between two Hamming spheres. So, the decoder is able to detect the error but not correct it. Thus, a DBE never leads to miscorrection when using SECDED. SECDED is the most commonly used rank level coding mechanism implemented within the DRAM controller (in-controller ECC).

In DDRx DIMM based systems, this is implemented as side-band ECC where the ECC bits are sent as sideband along with the actual data as part of the same read/write command and the encoding/decoding happens in the memory controller. For example, to support a (72,64) SECDED in-controller scheme, the DIMM data bus is 72-bits wide so that 64-bits of data and 8-bits of redundancy can be transferred in parallel. The DIMMs also have additional DRAM chip(s) per rank to store the parity bits. On the other hand, as LPDDR DRAMs are typically used as individual parts or in a package-on-package configuration, having additional data signals to fetch the ECC bits in the same cycle as the actual data adds an expensive overhead to these LPDDR devices. As a result, the in-controller ECC is implemented in-line where the ECC bits are stored in the same DRAM chips as the data and are transferred using the same data channel but through separate read/write commands.

### Motivation: Silent Data Corruption by On-Die ECC

Single bit errors are still the majority of the failures in today's DRAMs. Hence, DRAM manufacturers have started adopting on-die ECC for better reliability. Based on system level reliability analyses, the present Applicant recognizes that on-die SEC ECC helps to reduce system failures by more than 35%. However, it is ineffective for multi-bit errors and instead introduces unexpected miscorrection.

### Miscorrections Introduced by On-Die ECC

Consider the common example of a DRAM device with a (136,128) Single Error Correcting (SEC) Hamming code. This SEC code can correct any single-bit error in a 136-bit codeword. However, in case of a multi-bit error, there are two possible outcomes: (1) The errors go undetected since the code can only detect and correct a single-bit error. This case is equivalent to not having an on-die ECC mechanism. (2) The multi-bit error aliases to a single-bit error. This happens when the sum of the columns in the H-matrix of the decoder corresponding to the error positions is equal to another column in the matrix.

In order to better understand the second case, consider the following example SEC Hₑₓₐₘₚₗₑ parity-check matrix with 128 message bits and r=8 parity bits:

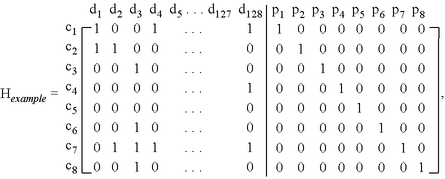

where dᵢ represents the ith data bit, pⱼ is the jth redundant parity bit and cₖ is the kth parity-check equation. In this H matrix, the sum of columns 1 and 2 is equal to column 4. Now, if a double-bit error occurs in bits 1 and 2, the resulting codeword c′ is equivalent to adding error patterns e₁ and e₂ to the original codeword c. By the definition of a linear block code, H.c=0 for all legal codewords c. Therefore, error patterns e₁ and e₂ isolate columns 1 and 2 of the SEC H matrix (i.e., H_{example*,1} and H_{example*,2}) and as shown in Equation 1, the resulting syndrome is the sum of the two columns.

$$s = {H}_{example} \cdot {c}^{′} = {H}_{example} \cdot ( c + {e}_{1} + {e}_{2} ) = {H}_{example} \cdot ( c + [ \begin{matrix}1 \\ 0 \\ 0 \\ 0 \\ 0 \\ 0 \\ 0 \\ 0\end{matrix} ] + [ \begin{matrix}0 \\ 1 \\ 0 \\ 0 \\ 0 \\ 0 \\ 0 \\ 0\end{matrix} ] ) = 0 + {H}_{{example}_{* , 1}} + {H}_{{example}_{* , 2}} = [ \begin{matrix}1 \\ 0 \\ 0 \\ 0 \\ 0 \\ 0 \\ 1 \\ 0\end{matrix} ] = {H}_{{example}_{* , 4}} \qquad ( 1 )$$

As seen in Equation 1, the sum of columns 1 and 2 of the Hₑₓₐₘₚₗₑ matrix is equal to column 4. Therefore, the generated syndrome s matches column 4. As a result, the decoder would consider it as a single bit error in bit position 4 and flip it as part of its correction mechanism. Thus, an originally double-bit error has now become a triple-bit error. On an average (across 10 random SEC Hamming code constructions), the average chances of a double-bit error miscorrecting to a triple bit error is >45%. With increasing DRAM error rates, recent studies have shown that the probability of a double-bit error occurring within the 128-bit dataword can be as high as ˜8×10⁻⁵, which translates to a double-bit error every 12500 SEC decoding cycles. Thus, the chances of a double-bit error converting to a triple-bit error are also high and will only increase in future.

### Silent Data Corruption as a Result of Miscorrection by On-Die SEC ECC

Now consider the problems that arise because of this miscorrection. SECDED code inside the memory controller is not designed to detect more than double-bit error. As a result, when the (136,128) SEC on-die ECC miscorrects and converts a double-bit error to a triple-bit error, there is a high probability (greater than 50% in most standard SECDED implementations) for the SECDED decoder to consider it as a single-bit error and further miscorrect. This will happen when the generated syndrome or the sum of three columns in the SECDED parity check matrix corresponding to the erroneous bits is equal to a fourth column. The probability of SDC depends on the exact SECDED code and the memory data transfer protocol.

The most widely reported on-die ECC mechanism is a (136, 128) SEC code and in-controller ECC is a (72, 64) SECDED code. The present disclosure will use these two codes for the purposes of explanation of one example code construction mechanism and double-bit error correction technique. However, those skilled in the art will understand that these example additional constraints while constructing these codes can be easily extended to other SEC and SECDED code constructions with different dataword and codeword lengths.

While more than 2-bit errors affecting a single 136-bit codeword is still rare, double-bit errors are becoming more probable with increasing bit error rate in recent DRAM generations built. Multiple recent experimental studies have considered DRAM raw bit error rate (BER) as high as 10⁻⁴. For different memory system architectures and data access protocols, we evaluate the probability of silent data corruption when a double-bit error occurs for bit error rates ranging from 10⁻⁴ to 10⁻⁸.

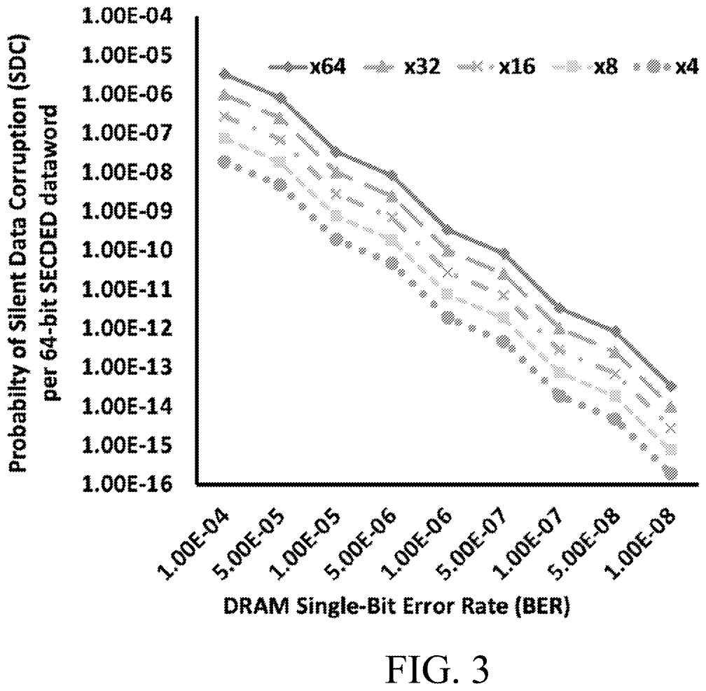

The result is shown in FIG. 3. This example evaluation considers the average miscorrection rate across ten different (136,128) on-die SEC and (72,64) in-controller SECDED implementations. The evaluation is performed for different access protocols; x64 means all 64-bits of SECDED dataword come from the same DRAM chip while x4 means there are 16 DRAM chips and each DRAM chips sends 4-bits per beat of memory transaction. For a BER of 10⁻⁴, the probability of silent data corruption in the common case of x16 data access protocol is non-negligible and can happen once every 3 million 64-bit accesses. As the data width per chip reduces, the SDC probability decreases. This is because the probability of a DBE, along with the miscorrected bit, aligning perfectly within the same beat boundary reduces with decrease in beat width. Without on-die SEC, the SDC probability, however, is 0 since all double-bit errors within the DRAM array, irrespective of location, would not get miscorrected and would be flagged as DUE by the in-controller SECDED decoder. Thus, while the SEC code does not help with detecting or correcting the double-bit errors in any scenario, it causes miscorrection and turns up to 25% of these DBE events into silent data corruption.

### COMET ECC Design to Eliminate Silent Data Corruption

In today's DDR or LPDDR based systems, during every read operation, the data that is read into the memory controller is typically striped across multiple DRAM dies. Each DRAM die has 4-bit, 8-bit or 16-bit wide data channel and multiple DRAM dies send data from the same address over their channels in parallel during each beat of memory transfer to construct the required 64-bit data. The 8-bit redundancy (for (72,64)SECDED) is either read from one or two additional DRAM dies in the same beat or read using a separate read command from the same dies as the actual data. On the other hand, the ECC data that gets decoded on-die is 128-bit wide. Only a part of this 128-bit data is accessed by the memory controller per operation (as will be described in more detail below) and therefore the data of on-die ECC eventually spans multiple in-controller SECDED codewords.

This has significant implications on SDC probability. As shown in FIG. 3, the smaller the number of bits from each DRAM die, the lower is the SDC probability. The double-bit error probability in a 128-bit word and the SEC induced miscorrection rate remains constant across the DRAM dies having the exact same SEC implementation. However, the probability of the double-bit error and the miscorrected bit coinciding within the same in-controller 64-bit dataword decreases with the decrease in the amount of data from each on-die codeword that constitutes the in-controller codeword. If all 64-bits come from the same DRAM chip and, therefore, from the same 128-bit SEC dataword, the SDC probability is ˜11× higher than the case where 6 DRAM chips send 4-bits each in parallel. The code constructions in accordance with the present embodiments, explained in detail below, exploit this data access pattern and adds additional constraints accordingly when implementing the corresponding SEC or SECDED codes.

### On-die SEC-COMET ECC

One way to avoid silent data corruption when a double-bit error occurs is by preventing the conversion from double-bit to triple-bit error by the SEC decoder. However, the number of redundant bits used in SEC coding is not enough to completely get rid of this miscorrection. One architectural aspect that the present embodiments exploit to get rid of silent data corruptions is the fact that the 72-bit SECDED codeword that gets decoded in the memory controller in every beat of memory transfer does not come from the same DRAM chip.

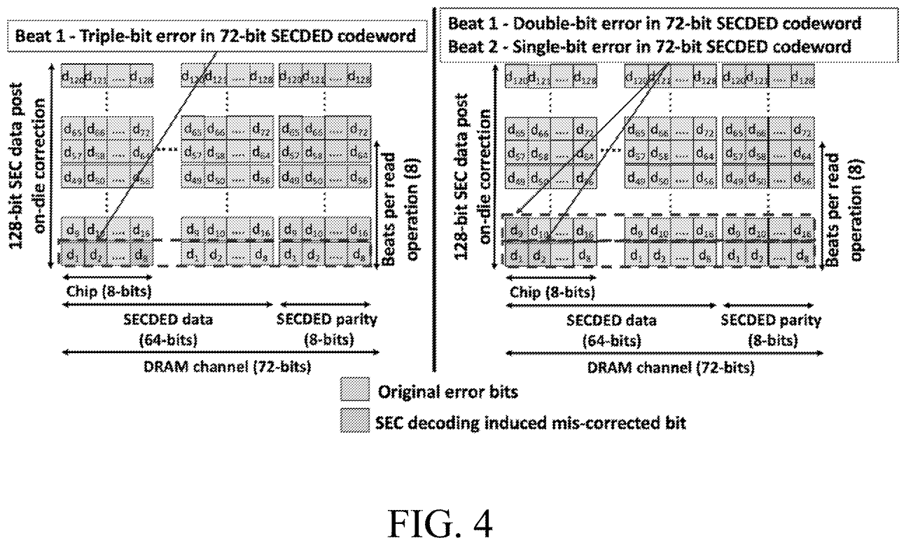

FIG. 4 illustrates an example showing how steering the miscorrected bit to a different beat transfer boundary during SEC decoding prevents the SECDED decoder from encountering the problematic triple-bit error within the same 72-bit codeword according to embodiments. As shown in FIG. 4, if all the three erroneous bits in the 136-bit codeword do not get transferred and decoded in the memory controller in the same beat, the SECDED decoder will not encounter a triple-bit error and silent data corruption can be avoided. Thus, the on-die SEC code has to be carefully constructed so that the miscorrection that happens because of any double-bit error gets steered to a bit that is beyond the single beat transfer boundary. This will ensure that the three erroneous bits never coincide in the same 72-bit SECDED codeword.

In order to achieve this property in a (136, 128) SEC code, within every beat transfer boundary, the sum of any two columns in the parity check H matrix should not be equal to a third column in the same set. With 8-bits of parity per 128-bits of dataword, this additional constraint can be satisfied when designing the SEC code for any data transfer protocol as long as the beat transfer boundary consists of 32-bits (32 columns) or less. Thus, as long as there are at least two DRAM chips that send data in parallel in each beat of memory transfer to form the 64-bit SECDED dataword (i.e., x4 to x32 DRAMs), the on-die SEC code can be constructed to guarantee no silent data corruption. Note that this SEC-COMET construction requires no knowledge of the in-controller SECDED code.

### In-controller SECDED-COMET ECC

An alternative to imposing the additional COMET constraint on on-die SEC ECC described above is to redesign the in-controller SECDED code, albeit with the knowledge of the SEC code used in the memory device. A recent work (e.g. M. Patel, J. S. Kim, T. Shahroodi, H. Hassan, and O. Mutlu, “Bit-exact ecc recovery (beer): Determining dram on-die ecc functions by exploiting dram data retention characteristics,” 2020) proposes an efficient way of reverse engineering the exact on-die SEC implementation. Using that framework, the exact parity check matrix of the SEC code can be known. This would provide information about the double-bit error positions that lead to miscorrection within the same beat transfer boundary for a given data access protocol and the position of that miscorrected bit. With that information known, the present Applicant has discovered that one can construct the in-controller SECDED to prevent silent data corruption when a double bit error happens.

The bit positions of every pair of double-bit error that leads to miscorrection within the same 64-bit SECDED dataword, along with the miscorrected bit position need to be mapped into their corresponding bit positions in the SECDED dataword. If one considers Hₑₓₐₘₚₗₑ provided above, errors in bit positions 1 and 2 in the 128-bit SEC dataword lead to miscorrection in bit position 4. Now, in a x8 DRAM architecture where the 64-bit dataword comprises of 8-bits from each of 8 DRAM chips, bit positions 1, 2 and 4 in the 128-bit SEC dataword fall within the same beat transfer boundary and correspond to the following bit positions (in their respective order) in the SECDED dataword (spanning 8 DRAM chips):
Bits 1, 2 and 4
Bits 9, 10 and 12
Bits 57, 58 and 60

This is because bit 1 of the SEC dataword from chip 1 would be bit 1 of the SECDED dataword, but bit 1 of the SEC dataword from chip 2 would be bit 9 of the SECDED dataword. The same is true for the rest of the DRAM chips.

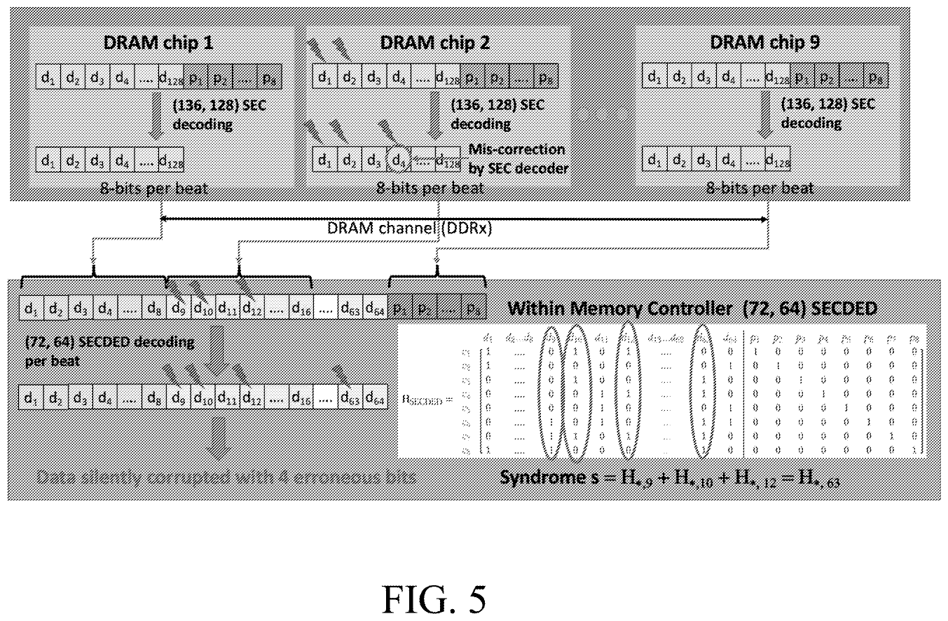

Consider the example shown in FIG. 5. A double-bit error happens in bits 1, 2 if chip 2 and bit 4 gets miscorrected by the SEC decoder. Post data transfer, this translates to three erroneous bits in positions 9, 10 and 12 in the SECDED codeword. What would eventually turn this into SDC is if the sum of these columns in the parity check matrix of the SECDED decoder is equal to a syndrome that matches another column (column 63 in the example in FIG. 5) in the H matrix. The decoder would match the generated syndrome (sum of columns 9, 10 and 11) to column 63 and hence, would think that there is a single-bit error in bit position 63. It would flag a correctable error and flip bit 63, silently further corrupting the data. The memory controller would consider the error correction as success and send the corrupted data over to the processor. In order to prevent this SDC from happening in a system with this particular on-die SEC code, the SECDED parity check matrix has to be designed such that the sum of all the sets of columns corresponding to the bit positions listed above should not match with any of the columns in the rest of the H matrix. The process has to be repeated for all bit triplets in the SEC dataword that lead to three-bit errors in the final SECDED codeword. For a given SEC code and system memory architecture, for every bit/column triplet in the SECDED H matrix that can cause SDC, the sum of the columns has to be such that it equals no other column in the H matrix.

Using this additional constraint, given the exact SEC implementation and the system architecture, it is possible to construct the SECDED code that would prevent SDC when double bit errors happen.

### COMET Collaborative Double Bit Error Correction

Overall, with inclusion of on-die ECC, for every 128-bits of actual data, 24-bits of redundant bits are stored in the memory. Despite the additional 6.25% storage overhead, on-die ECC does not improve error correction capability. Previous studies have shown that there is almost no difference in reliability between DIMMs with 8 chips that have only on-die ECC and DIMMs with 9 chips that support both on-die ECC and rank-level in-controller SECDED ECC. Thus, the two disjoint ECC schemes together do not reduce the overall system failure probability. Instead, if one of them is not carefully designed, it causes additional SDCs. In the present embodiments, an on-die SEC code and a controller-device provides a collaborative correction scheme to get nearly perfect double bit error correction.

### Constructing On-die SEC Code to Enable Double Bit Error Correction (SECCOMET-DBC)

In order to enable detection and correction of double-bit errors using syndrome matching, one needs to ensure that the sum of any pair of columns in the parity check matrix H of the code generates a unique syndrome. However, with just 8-bit redundancy for a 128-bit dataword, this can be achieved only for a small subset of columns. Embodiments add an additional constraint to SEC-COMET code construction from the above examples to construct the SEC-COMET-DBC code: for every set of x consecutive columns, the sum of every pair of columns within that set should be unique. For a (136, 128) SEC code, the maximum value of x (that is also a factor of 128) for which this can be possible is 16. For example, a valid SEC-COMET-DBC code can be constructed for x4, x8, x16 DRAM chips but not for x32. For such a SEC code, when a double-bit error occurs in bit positions that belong to the same x-bit chunk, the generated syndrome and the chunk position can be used to figure out the exact DBE locations. The syndrome is generated by the SEC decoder, but for the correction mechanism to work, the errors also have to be localized to the exact x-bit chunk which the SEC decoder is unable to do. This localization can exploit the memory data access architecture and utilize information from the in-controller SECDED decoder. For example, in a standard x8 DDR based ECC DIMM, the beat transfer width per chip is 8 and therefore, x=8 in the constraint of the (136,128) SEC-COMET-DBC code. Now when a double-bit error happens within the same 8-bit chunk in one of the DRAM chips, the beat in which the decoder flags a DUE will help to point to the 8-bit chunk position where the double-bit error has occurred. The subsequent paragraphs will discuss how this information can be sent to the DRAM chips and the double-bit error correction flow. For better understanding, the mechanism will be explained in a non-limiting example of a x8 DDR architecture, but those skilled in the art will be able to understand how to apply these principles to other architectures after being taught by these examples.

### COMET Collaborative Double Bit ErrorCorrection

To better understand the overall correction procedure and the required transfer of information between the memory controller and the DRAM chips, consider again the example of a memory subsystem comprising of x8 DDR based ECC DIMMs.

### Detecting the DBE beat

Consider all the possible ways a double-bit error can happen in a 136-bit codeword in a particular DRAM chip and the possible outcomes after the on-die and in-controller decoding.
Case 1: The two error bit positions are in two different 8-bit chunks and the miscorrected bit (if any) belongs to a third chunk. As a result the erroneous bits get sent over and decoded in the memory controller in separate beats. In each of these beats, the SECDED decoder flags a CE and corrects the error. Eventually all the erroneous bits get corrected and no DUE gets flagged.
Case 2: The two error bit positions are in two different 8-bit chunks and the miscorrected bit falls in the same chunk with one of the error bits. Now the 128-bit dataword after SEC decoding ends up with one 8-bit chunk that has two errors and another with a single-bit error. The memory controller SECDED decoder will flag a CE when it decodes the chunk with SBE but will flag a DUE when the 8-bit chunk with two error bits is decoded.
Case 3: The two error bit positions are in the same 8-bit chunk. The third constraint (provided in Section 4.1) that we added to the on-die SEC code construction will ensure that the miscorrected bit lands in a different 8-bit chunk. Thus, after SEC decoding the 128-bit dataword either has one 8-bit chunk with two errors (in the case of no miscorrection) or has an additional 8-bit chunk with a single-bit error. The SECDED decoder will flag a DUE when the 8-bit chunk with two error bits is decoded.

Overall it can be seen that if the double bit error and the miscorrected bit all end up in separate 72-bit SECDED codewords, they automatically get corrected by the in-controller decoder. However, if any two of them collide in the same codeword, the SECDED decoder would flag a DUE. Consider the example shown in FIG. 4 (Case 3). A double-bit error occurs in DRAM chip 1 in bits 1 and 2. Because of the improved SEC construction according to embodiments (shown on the right), it is ensured that the SEC decoder would steer the miscorrection to a different 8-bit chunk (in this example the miscorrected bit is 9). Therefore, during the first beat of memory transaction, the SECDED decoder flags a DUE, while in the second beat it flags a CE and corrects bit 9. The memory controller communicates this information to the DRAM chips using a special error correction command where it sends the original read command address and the beat number in which the DUE was flagged. The SECDED decoder cannot localize the double-bit error to a particular chunk in the codeword. Therefore, the double-bit error could have occurred in any of the 9 DRAM chips. Every DRAM chip receives the information from the memory controller that a DUE has been flagged in beat 1. Therefore, each DRAM now knows that in the first 8-bits of its 128-bit SEC dataword there might be a double-bit error.

### Correction Within Each DRAM Chip

Once the memory controller sends the special double-bit error correction command with the beat number, each DRAM chip checks the syndrome it had generated when the 136-bit codeword was passed through the SEC decoder during the original read operation. It is assumed that the special DBE correction command immediately follows the original READ command. Therefore, the DRAM chips only need to store the last generated 8-bit syndrome. If the syndrome was zero, the DRAM knows that the double-bit error did not occur in its codeword. In the example of FIG. 4, all DRAMs except chip 1 would have generated a zero syndrome. If the syndrome is non-zero, the correction mechanism within the chip would then try to match the syndrome with one of the H matrix columns in the 8-column set that corresponds to the received beat number. In this case, the beat number sent over by the memory controller is 1 and so, the first DRAM chip with a non-zero syndrome tries to match the syndrome against columns 1-8 in the H matrix. It is known that in this particular example the miscorrected bit position was 9. Therefore, the generated syndrome matches with column 9. Since the syndrome does not match with any of the columns in the target set, the decoder moves on to the next step where it matches the generated syndrome with the sum of every pair of columns from the first 8-column set. Because of the improved SEC construction according to embodiments, every pair of columns should sum up to a unique value. The pair of columns whose sum equals the generated syndrome (in this example it will be columns 1 and 2) represent the erroneous bit positions. The decoder would flip those two bits and send the corrected data over the DRAM bus to the memory controller. The rest of the DRAM chips would not take any action since they had zero syndrome and send the original 8-bit data that they had previously sent during the first beat.

While the example depicts the Case 3, consider what happens in Case 2. In this scenario, the original double bit errors are in two separate beat transfer chunks. But the miscorrected bit lands in the same 8-bit chunk as one of the two errors. Consider an example where this is the second 8-bit chunk. Thus, the SECDED controller flags DUE in the second beat and sends this information to the DRAM chips. When the erroneous chip matches the generated syndrome against columns 9 to 16 in the H matrix, it sees that the syndrome matches with the column corresponding to the miscorrected bit position. In this case, the DRAM chip would only flip that particular bit and send over the data to the DRAM controller. It will not be able to localize and correct the second error position within that 8-bit chunk. Considering the rest of the DRAM chips had zero syndrome, they send their unmodified data over in the same beat. Since the erroneous chip could only correct one bit, the overall data still has one-bit of error that SECDED will be able to correct.

### Final Correction Within the Memory Controller

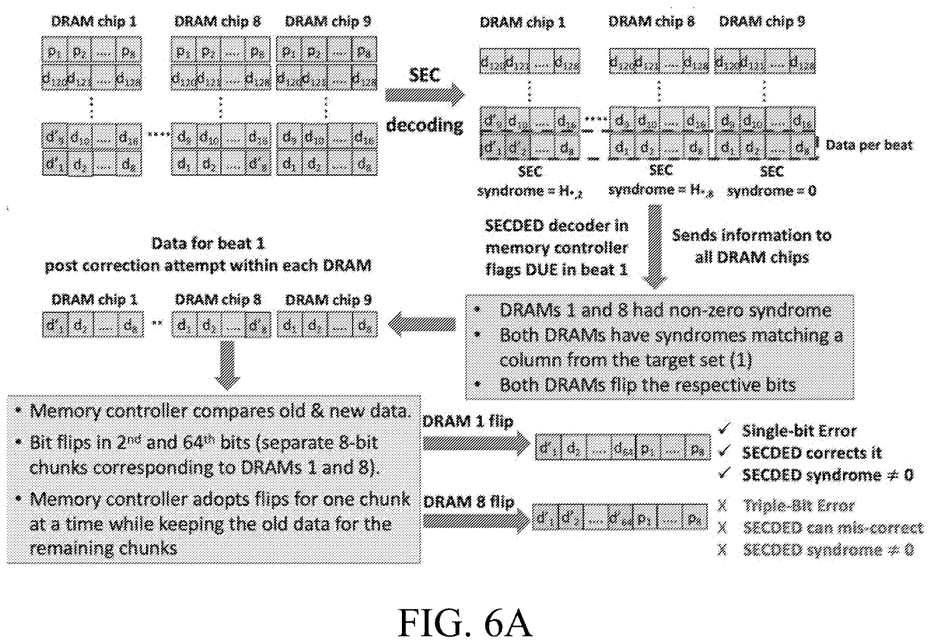

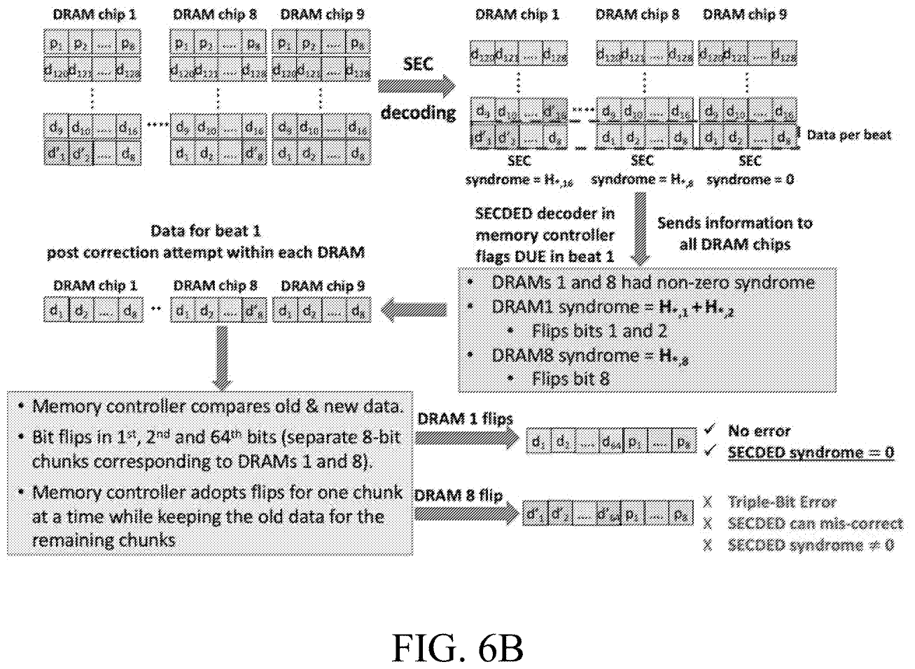

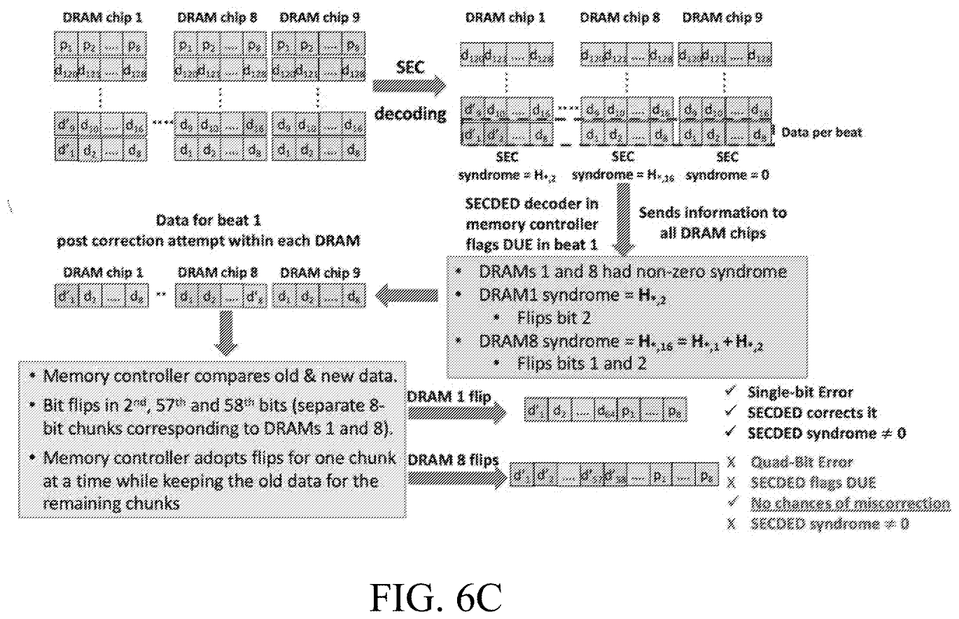

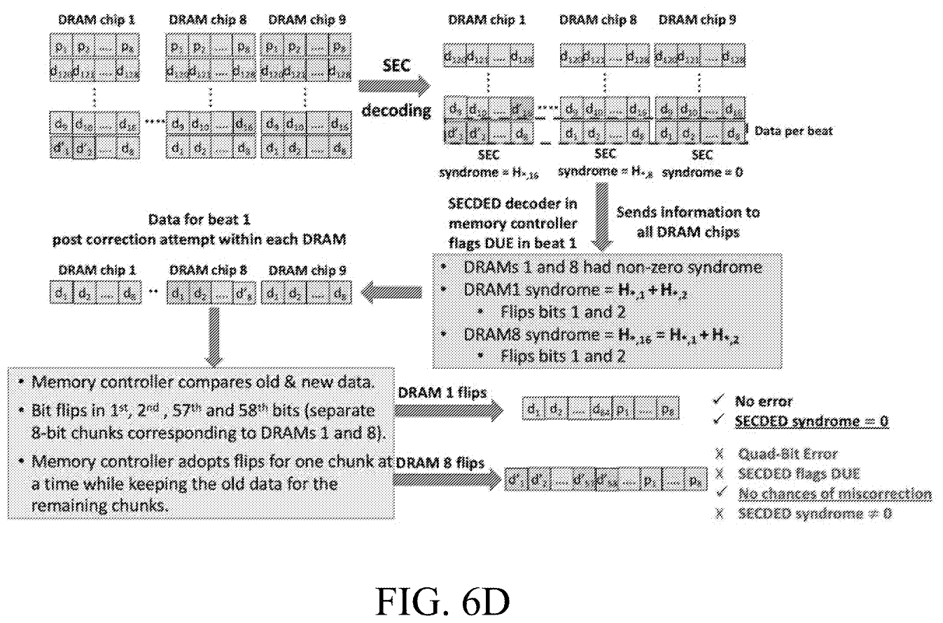

The final correction step in the DRAM controller involves multiple rounds of SECDED decoding of the corrected data. This is to provision for the rare cases where double-bit error in one chip coincides with single bit errors in other chips within the same 8-bit chunk and multiple DRAM chips encounter non-zero syndromes. The DRAM(s) in which the single-bit error falls within the same beat transfer boundary as the one in which DUE was flagged would match their generated syndrome with one of the columns in the target set and end up flipping the corresponding bit. Thus, while the DRAM with double bit error is able to correct one/two of the error bits, the other DRAMs with single bit errors and matching syndromes end up corrupting their data. This has to be dealt with in the DRAM controller in order to prevent silent data corruption. Once the controller receives the (mis) corrected 72-bit data from the DRAMs, it compares the corrected codeword with the one it had received during the original read. In the ideal case where only a single DRAM chip has double-bit error and no other chip has made any corrections, the two codewords would differ by one/two bits within a particular 8-bit boundary corresponding to the erroneous chip. However, if multiple DRAM chips send modified data, the controller, post comparison, would find bit flips in more than one 8-bit chunk. To prevent miscorrection and silent data corruption, the controller accepts changes corresponding to each chip one at a time. The possible scenarios are shown in FIGS. 6A to 6D, and described below.

FIG. 6A illustrates an example of DBE Case 2 (Chip 1)+SBE (Chip 8) in same 8-bit chunk.

Post correction, the data received by the memory controller is two flips away from the old data. Each of the two flips are in separate 8-bit chunks and, therefore, is assumed to be introduced by two separate DRAM chips. Chip 1 has corrected the miscorrected bit while chip 8 has accidentally flipped the previously corrected bit, making it wrong again. The controller accepts corrections corresponding to one chip at a time and sends the corrected data through the SECDED decoder. When chip 1 correction is considered, the resulting data ends up with a single-bit error. This is because, the rest of the data bits are the same as it was in the pre-correction data and therefore, the post-correction accidental flip by chip 8 has been replaced by the right data. The only error bit corresponds to one of the double-bit error locations and the SECDED decoder corrects it. However, when chip 8 correction is considered, the resulting data ends up with triple-bit errors. The SECDED decoder, in this case, either flags a DUE or considers it as a correctable single bit error if the syndrome matches with a H column. If it flags a DUE, the controller rejects this case, accepts the corrections from chip 1, considers the SECDED correction as legal and moves ahead. If both attempts lead to SECDED correction, the controller panics and declares the DBE uncorrectable.

FIG. 6B illustrates an example of DBE Case 3 (Chip 1)+SBE (Chip 8) in same 8-bit chunk.

Post correction, the data received by the memory controller is three flips away from the old data. Two of the bit flips are in the same 8-bit chunk while the third is in a different one. Chip 1 has corrected both double-bit errors while chip 8 has accidentally flipped the previously corrected bit, making it wrong again. The controller accepts corrections corresponding to one chip at a time and sends the corrected data through the SECDED decoder. When chip 1 correction is considered, the resulting data is error free. The SECDED decoder returns a zero syndrome. However, when chip 8 correction is considered, the resulting data ends up with quad-bit errors. The SECDED decoder, in this case, flags a DUE. The controller rejects this case, accepts the corrections from chip 1 and moves ahead.

FIG. 6C illustrates an example of DBE Case 2 (Chip 1)+SBE (Chip 8) in a different 8-bit chunk.

In this case, even though the SBE in chip 8 is in a different 8-bit chunk (b16), sum of two H columns in the target 8-bit chunk equal column 16. Therefore, during correction, the decoder would think that there are two errors in the target 8-bit chunk and flip the respective bits. Thus, post correction, chip 1 is able to correct one of the two errors but chip 8 has introduced two additional error bits. The data received by the memory controller is three flips away from the old data. Two of the bit flips are in the same 8-bit chunk while the third is in a different one. The controller accepts corrections corresponding to one chip at a time and sends the corrected data through the SECDED decoder. When chip 1 correction is considered, the resulting data ends up with a single-bit error. The SECDED decoder corrects the error. However, when chip 8 correction is considered, the resulting data ends up with quad-bit errors. The SECDED decoder, in this case, flags a DUE. The controller rejects this case, accepts the corrections from chip 1 and moves ahead.

FIG. 6D illustrates an example of DBE Case 3 (Chip 1)+SBE (Chip 8) in a different 8-bit chunk.

Same as in the example of FIG. 6C, chip 8 has accidentally flipped two bits in its data post correction. Chip 1, however, manages to correct both double-bit errors. The data received by the memory controller is four flips away from the old data, two flips in each 8-bit chunk. When chip 1 correction is considered, the resulting data ends up error-free. The SECDED decoder generates a zero syndrome. However, when chip 8 correction is considered, the resulting data ends up with quad-bit errors. The SECDED decoder, in this case, flags a DUE. The controller rejects this case, accepts the corrections from chip 1 and moves ahead.

From the detailed breakdown of the four scenarios it can be seen that the correction mechanism is able to successfully correct in three of them. The likelihood of the uncorrectable case is 1 in 300,000. I.e., COMET achieves 99.9997% double bit error correction.

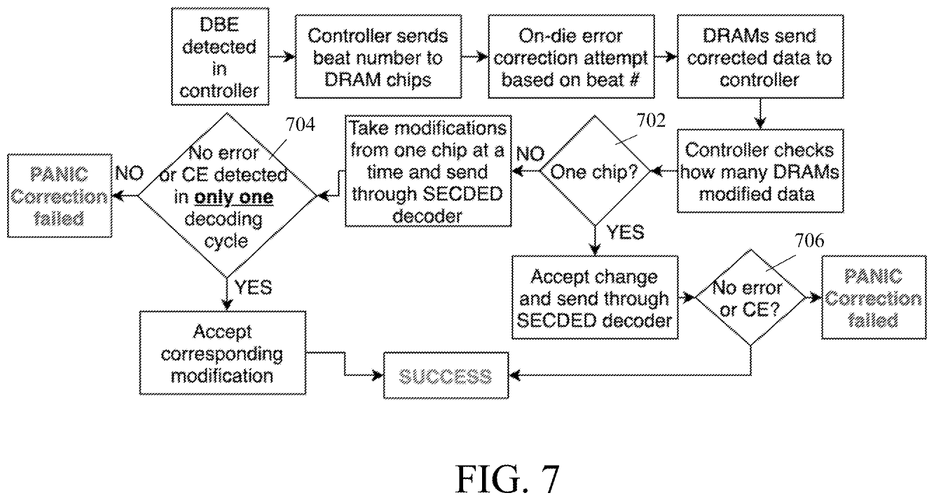

A flowchart illustrating an example step-by-step correction mechanism of DBEs by COMET in accordance with embodiments is shown in FIG. 7.

As shown in FIG. 7, first a DBE is detected in the controller.

Next, the controller sends the beat number to the DRAM chips.

Next, on-die error correction is attempted based on this beat number in the DRAM chips.

Then, the DRAMs send corrected data to the controller.

Next the controller checks how many DRAMs modified the data.

For example, it is checked in 702 whether only one chip modified the data.

If not one chip in 702, the controller takes modifications from one chip at a time and sends them through a SECDED decoder in the controller.

Then it is checked in 704 whether there is no error or CE detected in only one decoding cycle by the SECDED decoder.

If the answer from 704 is NO, then a PANIC, Correction failed is the result.

If the answer from 704 is YES, the corresponding modifications from one chip at a time are accepted, and then a final SUCCESS is the result.

If the result from 702 is that only one chip modified the data, the change is accepted and sent through the SECDED decoder.

Next in 706 it is checked if the output of the SECDED decoder shows no error or CE.

If the answer from 706 is NO, then a PANIC, Correction failed is the result. p If the answer from 706 is YES, then a final SUCCESS is the result.

A similar correction outcome is expected if there is link error instead of single-bit error in the data signals of the other chips. The probability of double-bit error striking two different DRAM chips within the same beat transfer boundary is less than 2×10⁻¹⁰ with BER of 10⁻⁴. Therefore, embodiments only consider up to single bit error in the other DRAM chips.

### Implementation of COMET Commands within DDR Protocol

As mentioned before, the double-bit error correction mechanism in COMET requires the DRAM controller to send a special correction command to the DRAM devices to initiate the on-die correction. This special command will need to also send the exact beat number during which the DUE was flagged along with the rest of the column address. This special command will be sent right after the original read command, so DRAM devices with open page policy would not require an additional ACTIVATE command as the row will be left open in the row buffer. For devices with closed page policy, the controller would have to send an additional ACTIVATE command to re-open the target row before the special correction command. In DDR4/LPDDR4 standards, there are typically one or more spare command sequences that are reserved for future use (RFU). One such RFU command sequence can be used to support this special command. Table 1 lists a possible command sequence for DDR4 and LPDDR4 protocols that can be used for COMET DBE correction. In DDR4 it will be a single cycle single command sent on the rising edge of the clock while in LPDDR4 it will be a multi-cycle multi-command sent on successive rising clock edges like their standard read/write operations. This is because in LPDDR, the command and address buses are multiplexed while in DDR there are separate buses for command and address. In DDR4 protocol, address bits A[2:0] determines how the beats would be ordered when sending the data from a particular column address [16, 17] during a read operation. For example, A[2:0]=“010” would send beat number 2 first followed by beats 3, 0, 1, 6, 7, 4, 5, while A [2:0]=“101” would send beat 5 first followed by beats 6, 7, 4, 1, 2, 3, 0. The same address bits can be used in our special command to denote the target beat in which DUE had occurred and the DRAM device would correct and send data accordingly. Similarly, in LPDDR4 protocol [18, 19], C[4:0] of the 10-bit column address (C0 to C9) is used to determine the beat ordering during read operation and can be re-purposed in our special command to send the target beat number. Also, both protocols support burst chop, which allows the DRAM devices to send reduced number of beats during the memory transaction. Since we need only a single beat post correction from the DRAMs, the special command can enable burst chop. In DDR4, BC_n is set to LOW for a burst size of 4 beats instead of the standard 8 beats. In LPDDR4, the CA5 pin in the first cycle can be set to LOW for the shortest burst length.

### Example Reliability Evaluation Results

In a system using x8 DDRx protocol based DRAMs with scaling induced bit error rate of 10⁻⁴ and on-die SEC mechanism, a double-bit error in a 572-bit memory line that causes the SECDED decoder to flag a DUE can happen once every ˜17000 read operations. This rate is 1.4× higher that that without on-die ECC because now miscorrections caused by on-die ECC can coincide with an error location within the same beat transfer boundary and convert a correctable single bit error to a DUE.

The present Applicant evaluated the impact of double-bit error and silent data corruption caused by these errors on system-level reliability through a comprehensive error injection study. While, in most cases, SDCs corrupt the final result or lead to unexpected crashes and hangs during the run of an application, some SDCs might get masked and would eventually have no impact on the final output. Since COMET ensures that none of the double-bit errors result in SDC, an objective is to understand the severity of on-die ECC induced SDCs in the event of a double-bit error without COMET in order to evaluate the usefulness of COMET.

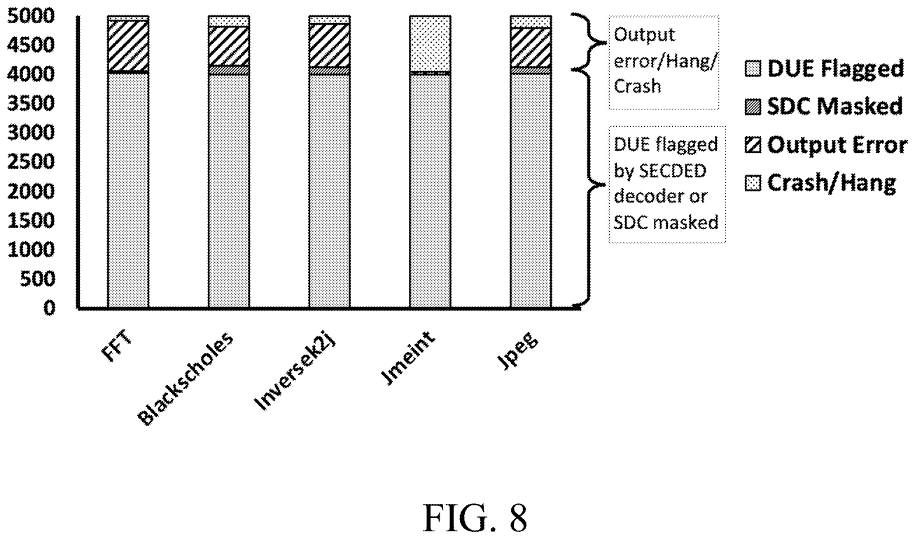

The present Applicant selected a random implementation of a (136, 128) SEC on-die code that obeys the basic constraints of a Hamming code and only ensures single-bit error correction. For the in-controller ECC, selected was a conventional (72, 64) Hsiao SECDED code that is known to be widely used. Since approximation tolerant applications are expected to be least impacted by SDCs, used were benchmarks from the AxBench suite for this study. Built was an AxBench against GNU/Linux for the open-source 64-bit RISC-V (RV64G) instruction set v2.0 using the official tools. Each benchmark is executed on top of the RISC-V proxy kernel using the Spike simulator that was modified to inject errors. A modified version of Spike was used to run each benchmark to completion 5000 times. During each run, a load operation is randomly chosen and a double-bit error is injected in a 128-bit word. The 128-bit SEC code decodes the erroneous codeword where there is a 45% chance of miscorrection. Post SEC decoding, the data is sent through the SECDED decoder which again has a 55% chance of miscorrecting and corrupting the data. For the remaining 45% of the cases, the system declares a DUE and crashes. The effects on program behavior for the cases where DUE is not flagged were observed and, therefore, corrupted data is sent over to the processor. The results are shown in FIG. 8. Overall, on an average, ˜80% of the double bit errors are flagged as DUE while less than 2% of the times the resulting SDC gets successfully masked by the application. ˜12%, on an average, result in erroneous output with a non-negligible impact on output quality and for the rest of the cases, the program either hangs or crashes.

SEC-COMET or SECDED-COMET code constructions completely eliminate SDCs converting output errors or crashes in the 18% to more acceptable DUEs. SEC-COMET-DBC corrects nearly all of these errors, i.e., 98% point improvement in DBE reliability.

TABLE 1
COMET DBE Correction Command Sequence in DDR4 and LPDDR4
protocols
DDR4

| | | Prev. CKE/ | | | | | | |
|---|---|---|---|---|---|---|---|---|
| Signals | Clock Edge | Pres. CKE | CS_2 | ACT_n | RAS_n/A16 | CAS_n/A15 | WE_n/A14 | A[13, 11] |
| COMET_special | R1 | H | L | H | L | H | H | Valid Sigal |
| Signals | | BG[1:0] | BA[2:0] | C[2:0] | A12/BC_n | A10/AP | A[2:0] | A[9:3] |
| COMET_special | | BG | BA | Valid Signal | L | L | Target Beat | Column |
| | | | | | | | number | Address |

LPDDR4

| Signals | Clock Edge | CS | CA0 | CA1 | CA2 | CA3 | CA4 | CA5 |
|---|---|---|---|---|---|---|---|---|
| COMET_special-1 | R1 | H | L | H | L | H | L | BL (L) |
| | R2 | L | BA0 | BA1 | BA2 | C0 | C9 | C1 |
| | | | | | | (Target Beat) | | (Target Beat) |
| COMET_special-2 | R1 | H | L | H | L | H | H | C8 |
| | R2 | L | C2 | C3 | C4 | C5 | C6 | C7 |
| | | | (Target Beat) | (Target Beat) | (Target Beat) | | | |

### Example Effectiveness of COMET Double Bit Correction

The present Applicant evaluated the reliability of a system with 128 GB DRAM with three different error correction schemes: no on-die ECC, standard SEC ECC and SEC-COMET-DBC scheme. Used was a fault simulator MEMRES with real world field data. Scaling induced bit error rate of 10⁻⁴ were considered for this study. The system has 2 channels, each containing dual ranked DIMM of 64 GB capacity with 18 x8 DRAMs. In all three systems considered was in-controller SECDED protection. Monte Carlo simulations were performed for a 5 year period and considered were both undetected as well as detected-but-uncorrectable errors as system failures.

For each failure mode, it was seen overall that adding on-die SEC coding significantly helps in improving device failure by 35% over the system without any on-die coding. The main failure mode that on-die ECC takes care of is single bit permanent fault intersecting with a single-bit transient fault (SBT) in the array or the bus. The SBT in the array is taken care of by the occasional scrubbing that is enabled in the DRAMs and the intersection with bus faults is taken care by the on-die and in-controller ECCs. With COMET-SEC-DBC, the present embodiments can achieve a 8.2% reduction in system faults over standard SEC, which translates to more than 150 lesser failures per year. This improvement in memory resiliency comes from double bit correction which helps to reduce single-row failures and single-word failures.

### Example Impact on Encoder/Decoder Area, Energy and Latency

COMET adds additional constraints during the construction of the on-die SEC and in-controller SECDED codes to avoid silent data corruption and to enable double-bit error correction. While none of the code constructions require additional redundancy bits, the encoder and decoder circuitry overheads varies based on the exact code implementation. DRAM manufacturers would want to implement the on-die SEC code with the minimum encoder and decoder area, power and latency overheads. In order to evaluate our proposed SEC code overheads, synthesized were a few different SEC implementations along with our construction using a commercial 28 nm library. Considered was the SEC code with the minimum possible sum of the weight of the columns in the parity check matrix H as the most efficient implementation in terms of gate count. Also it was compared against a random SEC implementation which satisfies the basic Hamming code constraints required for single error correction. The area, latency and power overheads of the different decoders are listed in Table 2.

TABLE 2
Synthesis Results for Different ×8 SEC Decoder
Implementations in Commercial 28 nm Library

| | | | SEC- | SEC- |
|---|---|---|---|---|
| | SEC- | SEC-best | COMET-DBC | COMET-DBC |
| | random | case | (×8) | (×16) |
| Gate Count | 168 | 165 | 170 | 170 |
| Area (um2) | 331.452 | 318.168 | 328.374 | 332.91 |
| Latency (ps) | 512 | 508 | 517 | 520 |
| Power (W) | 2.12E−05 | 1.93E−05 | 2.09E−05 | 2.12E−05 |

Based on the results, it can be seen that the difference in area (<5%), latency (<2.5%) and power (<9.7%) among the different SEC decoders is minimal and negligible. Furthermore, on-die ECC consumes a very small fraction of the overall DRAM active power (˜5-7%).

### Example Performance Impact of SEC-COMETDBC

SEC-COMET has no performance impact. To evaluate COMET's correction mechanism's impact on performance, used was cycle based simulation of 18 SPEC CPU 2017 benchmarks on the Gem5 simulator. The present Applicant used a 2 GHz eight-core processor with a private 32 KB I-cache, 64 KB D-cache, shared 512 KB L2 cache and shared 8 MB L3 cache. For once every 17000 read operations, doubled were the read latency and added 9 cycle penalty for the DBE correction. This is to consider the worst case where a double-bit error in one chip is accompanied by single bit errors in the remaining DRAM chips. Evaluated were the DDR4-2400-x8 memory configuration with a 64 b data channel for 2-billion instructions. The overall performance impact was less than 1%. This is because one additional memory read every 17k reads is still rare and has negligible impact on queuing delay and overall execution time. Note that, in absence of SEC-COMET-DBC, this would require checkpoint-recovery performance cost of which may be much, much higher (30 minutes to restore checkpoint).

Though DRAM technology is different compared to logic technology, the comparison between different implementations should still hold.

### Discussion

### Overheads of Using Stronger In-controller ECC codes

COMET proposes efficient constructions of two widely used on-die and in-controller ECCs for stronger and safer correction of memory errors without requiring any storage overhead or change in protocol. Using stronger on-die coding such as double error correcting requires twice the number of parity bits, and doubles the latency of decoding and error correction and significantly increases the area and power overhead of the encoder/decoder circuitry. Similarly, using a double-error correcting, triple error detecting (DECTED) scheme in the memory controller will require additional DRAM chips per rank and extra data lines to store and transfer the extra parity bits. For every 64-bits of dataword, DECTED requires 7 extra parity bits as compared to SECDED. In some high performance, high-reliability expensive systems today, single symbol correcting, double symbol detecting (SSCDSD, also known as Chipkill) coding is used to tolerate up to single chip failures. However, Chipkill requires two additional DRAM chips to store the redundant bits. Also, the standard 4-bit symbol Chipkill code used today can support only x4 DRAM chips. In order to use x8 DRAM, one data access will have to be split into two, which will have a significant impact on performance. Entire chip failures are very rare and, therefore, Chipkill is considered an overkill in most systems today.

### Related Work: Stronger Reliability Techniques

Several past works have proposed stronger memory reliability but most of them do not improve on-die ECC or incur overheads and require changes to the standard protocol. XED proposes using error detection within each DRAM die and then exposing the detection result to the in-controller code for correction. But they assume that on-die codes implemented in today's DRAM have guaranteed double-error detection capability while in most known cases, the on-die code only guarantees single-error correction. Therefore, using the same code for multi-bit error detection will not be effective as the code would miscorrect and declare a multi-bit error as SBE. Besides, if two DRAM chips have errors within the same beat boundary they cannot be corrected. Other proposals such as Frugal-ECC enhances the reliability of non-ECC DIMMs by adding parity bits to compressed memory lines. Therefore, the maximum achievable reliability is limited by the compressibility of the memory lines. Software Defined Error Correcting Code (SDECC) proposes using software based heuristic recovery from DUEs. However, the correction is prone to miscorrections and is limited by the value locality of the nearby words in the cache line. Other proposed reliability techniques like Bamboo-ECC uses large ECC symbols and codewords to provide stronger protection while incurring performance overhead. ArchShield provides protection against single-bit scaling induced errors but requires storing of fault maps within the DRAMs that would need to be updated in-field that requires running full array testing using a Built-In Self Test (BIST) engine. CiDRA proposes using on-die ECC to provide protection against multi-bit failures. However, it requires large SRAM overheads that makes its usage prohibitive. COMET requires no additional storage overheads, no changes to the existing memory standards and still allows the DRAM manufacturers to silently correct the single-bit errors in the memory array without making SBE events visible to the rest of the system.

### Accommodating Wider Data Access Protocols

As mentioned above, with 8-bits of parity for 128-bits of dataword, SEC-COMET (SEC-COMET-DBC) construction works up to per-chip beat width of 32 (16) bits. If all 64 bits of the SECDED dataword in the controller come from the same DRAM chip (single chip beat width of 64-bit), COMET cannot avoid SDCs or correct DBEs. To enable COMET, the 64-bit SECDED dataword would have to be formed using multiple 128-bit SEC datawords. Therefore, within the DRAM chip, every 16-bits of the 64-bit data transferred needs to be a part of a different 128-bit SEC dataword. Thus, a single write or read command would require multiple rounds of on-die SEC encoding and decoding. Typically, during a read/write operation, an entire DRAM row gets activated into the row buffer. The size of a DRAM row is usually few kBs and therefore, contains multiple SEC datawords. Hence, to enable COMET for wider per chip beat widths, the multiple on-chip encoding and decoding can be done in parallel and would not requial activations of DRAM rows.

### Conclusion

Aggressive technology scaling in modern DRMs is leading to a rapid increase in single-cell DRAM error rates. As a result, DRAM manufacturers have started adopting on-die error-correcting coding (ECC) mechanism in order to achieve reasonable yields. The most commonly used on-die ECC scheme is single-error correcting (SEC) code. System architects typically add another layer of SECDED ECC within the memory controller to improve memory reliability. Without on-die ECC, any double bit errors are detected by in-controller SECDED code. However, with on-die SEC ECC, double-bit errors have more than >45% chance of getting miscorrected to a triple-bit error. When the in-controller SECDED decoder receives a triple-bit error, it has >55% chance of further miscorrecting and eventually causing silent data corruption (SDC). To prevent silent data corruption from happening, the present embodiments provide a Collaborative Memory ECC Technique (COMET), a mechanism to efficiently design the on-die SEC ECC and the in-controller SECDED ECC that steers the miscorrection to guarantee that no silent data corruption happens when a double-bit error occurs inside the DRAM. Further developed is the SEC-COMET-DBC on-die ECC code and a collaborative correction mechanism between the on-die and in-controller ECC decoders that allow designs to correct the majority of the double-bit errors within the DRAM array without adding any additional redundancy bits to either of the two codes. Overall, COMET can eliminate all double-bit error induced silent data corruptions and correct 99.9997% of all double bit errors with negligible area, power and performance impact.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably coupleable,” to each other to achieve the desired functionality. Specific examples of operably coupleable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

Although the present embodiments have been particularly described with reference to preferred examples thereof, it should be readily apparent to those of ordinary skill in the art that changes and modifications in the form and details may be made without departing from the spirit and scope of the present disclosure. It is intended that the appended claims encompass such changes and modifications.

1. A method comprising:
performing on-die error correction coupled with in-controller error correction; and
configuring on-die ECC codes to avoid all error miscorrections by an in-controller ECC decoder.

2. The method of claim 1, further including configuring the in-controller ECC codes with knowledge of the on-die ECC codes.

3. The method of claim 1, wherein configuring the on-die ECC codes further guarantees no silent data corruption when a double-bit error happens within the DRAM.

4. The method of claim 1, wherein the on-die ECC comprises SEC.

5. The method of claim 1, wherein the in-controller ECC comprises SECDED.

6. A method for providing a collaboration mechanism between on-die and in-controller ECC decoders, comprising:
correcting double-bit errors without adding any additional redundancy bits to either of the two codes.

7. The method of claim 6, further including avoiding all error miscorrection.

8. The method of claim 6, wherein the on-die ECC codes are configured to avoid all error miscorrections.

9. The method of claim 8, wherein the in-controller codes are designed with knowledge of the on-die ECC codes.

10. The method of claim 6, wherein the on-die ECC comprises SEC.

11. The method of claim 6, wherein the in-controller ECC comprises SECDED.

12. A method of avoiding miscorrections between an in-controller ECC decoder and a plurality of on-die ECC decoders comprising:
detecting a double bit error by the in-controller ECC decoder;
sending, by the in-controller ECC decoder, the beat number to the plurality of on-die ECC decoders;
attempting, by the plurality of on-die ECC decoders, error correction based on the beat number; and
sending a respective plurality of corrections from the plurality of on-die ECC decoders to the in-controller ECC decoder.

13. The method of claim 12, further comprising:
checking the respective plurality of corrections to determining how many on-die ECC decoders modified the data.

14. The method of claim 13, wherein if only one on-die ECC decoder modified the data, sending the modified data to the in-controller ECC decoder.

15. The method of claim 13, wherein if more than one on-die ECC decoder modified the data:
sending the plurality of corrections one at a time through the in-controller ECC decoder;
determining if there is no error or a CE detected in only one decoding cycle by the in-controller ECC decoder.
